(19) United States
(12) Patent Application Publication
(10) Pub. No.: US 2011/0318644 A1
(43) Pub. Date: Dec. 29, 2011

(54) AMPHOTERIC ION EXCHANGE MEMBRANES

(76) Inventors: Maolin ZHAI, Beijing (CN); Jingyi Qiu, Beijing (CN); Jing Peng, Beijing (CN); Ling Xu, Beijing (CN)

(21) Appl. No.: 12/825,795

(22) Filed: Jun. 29, 2010

(51) Int. Cl. H01M 2/16; C08J 5/22

(52) U.S. Cl. 429/249; 429/247; 521/27

(57) ABSTRACT

An amphoteric ion exchange membrane for use in a vanadium redox flow battery has a vanadium ion permeability of less than 10×10⁻⁹ cm²/min.

The present technology generally relates to batteries and ion exchange membranes.

### BACKGROUND

In the past several decades, much attention has been focused on vanadium redox flow batteries (VRFB) which are a promising system for energy storage having a flexible design, a deep-discharge capability, a long cycle life, and low cost. The VRFBs have a positive half-cell that includes VO₂⁺ and VO²⁺, and a negative half-cell that includes V³⁺ and V²⁺. The positive and negative half-cells are separated by ion exchange membranes (IEMs). Such IEMs are a key component in the VRFBs and are used to limit the crossover of vanadium ions while allowing for the transport of ions to complete the conducting circuit. For the sake of high energy efficiency and long cycle life, an IEM for a VRFB should be designed with low permeability of vanadium ions and high conductivity, while providing acceptable stability. Nevertheless, the current available commercial membranes cannot satisfy the range of such requirements. For example, an anionic ion exchange membranes, show poor stability in VRFB electrolyte solutions due to the oxidation decomposition induced by V(V) ions; while sulfonated tetrafluoroethylene based fluoropolymer-copolymers with high conductivity and excellent chemical stability, suffer from the crossover of vanadium ions, as well as high cost.

### SUMMARY

Through a two-step grafting approach, an amphoteric ion exchange membrane (AIEM) for use in a VRFB is provided. The membrane conductivity and the permeability of vanadium ions through the AIEM can be conveniently controlled by changing the grafting yield (GY) in the two steps. The AIEM exhibits advantages over both anion exchange membranes and cation exchange membranes in VRFB applications. For example, the AIEM provides for a lower permeability of vanadium ions than cation exchange membranes due to the Donnan exclusion effect, and provides for higher conductivity in comparison to anion exchange membranes. Finally, the AIEM shows good suitability in VRFB.

In one aspect, an amphoteric ion exchange membrane for use in a vanadium redox flow battery is provided, where the membrane has a vanadium ion permeability of less than 10×10⁻⁹ cm²/min. In some embodiments, the vanadium ion permeability is less than 6×10⁻⁹ cm²/min. In some embodiments, the vanadium ion permeability is less than 3×10⁻⁹ cm²/min.

In some embodiments, the amphoteric ion exchange membrane may include a grafted polymer film represented by the following formula:

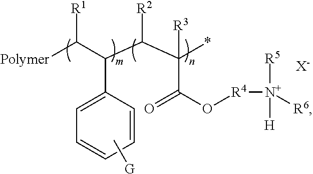

where R¹, R², R³, R⁵, and R⁶ are independently H, alkyl, alkenyl, alkynyl, cycloalkyl, or heterocyclyl; R⁴ is an alkylene or alkenyloxy; X is an anion; G is COOA, PO₄A, or SO₃A; each A is H or a cation; m is an integer from 100 to 10000; n is an integer from 60 to 6000; and x is an integer from 1 to 5.

In some embodiments, R¹, R², R³, R⁵, and R⁶ are independently H or alkyl. In some embodiments, R¹, R², R³, R⁵, and R⁶ are independently H or C₁-C₆ alkyl. In some embodiments, R¹ and R² are H. In some embodiments, R³, R⁵, and R⁶ are independently alkyl. In some embodiments, R³, R⁵, and R⁶ are independently C₁-C₆ alkyl. In some embodiments, R¹ and R² are H and R³, R⁵, and R⁶ are independently alkyl. In some embodiments, R¹ and R² are H and R³, R⁵, and R⁶ are independently C₁-C₆ alkyl. In some embodiments, R¹ and R² are H and R³, R⁵, and R⁶ are methyl. In some embodiments, R⁴ is alkylene. In some embodiments, R⁴ is C₁-C₁₂ alkylene. In some embodiments, R⁴ is —CH₂— or —CH₂CH₂—. In some embodiments, R¹ and R² are H; R³, R⁵, and R⁶ are methyl; and R⁴ is —CH₂— or —CH₂CH₂—.

In some embodiments, X is F⁻; Cl⁻; Br⁻; I⁻; NO₃⁻; CN⁻; ClO₄⁻; BF₄⁻; AsF₆⁻; SbF₆⁻; PF₆⁻; CF₃SO₃⁻; or B(C₆F₅)₄⁻.

In some embodiments, A is independently H, Na⁺, K⁺, or NR₄¹⁰, and each R¹⁰ is independently H or alkyl.

In some embodiments, G is SO₃A. In some embodiments, x is 1 and A is H.

In some embodiments, m is an integer from 500 to 8000. In other embodiments, n is an integer from 300 to 6000.

In some embodiments, the polymer includes poly(tetrafluoroethylene), or a co-polymer thereof. In some such embodiments, the polymer includes poly(ethylene-co-tetrafluoro ethylene).

In another aspect, a vanadium redox flow battery is provided including any of the above amphoteric ion exchange membranes. In such embodiments, the vanadium redox flow battery may also include a positive half-cell including VO₂⁺ and VO²⁺. In such embodiments, the vanadium redox flow battery may also include a negative half-cell including V³⁺ and V²⁺. In some embodiments, the battery also includes an electrolyte. In such embodiments, the electrolyte includes H₂SO₄.

In another aspect, a method is provided including preparing a mixture of a polymer, a styrenic monomer, and a (meth)acrylic monomer; subjecting the mixture to γ-irradiation to produce a grafted polymer film; sulfonating the grafted polymer film to form a sulfonated grafted polymer film; and hydrolyzing the sulfonated grafted polymer film to produce an amphoteric ion exchange membrane. In some embodiments, the styrenic monomer is styrene. In other embodiments, the (meth)acrylic monomer is dimethylaminoethyl methacrylate. In some embodiments, the sulfonating includes reacting the grafted polymer film with chlorosulfonic acid. In some embodiments, the hydrolyzing includes reacting the sulfonated grafted polymer film with water. In some embodiments, the γ-irradiation is provided by a ⁶⁰Co source.

### BRIEF DESCRIPTION OF THE DRAWINGS

FIG. 1 is a graph of grafting yields of styrene into a poly(ethylene-co-tetrafluoroethylene) (ETFE) film, dimethylaminoethyl methacrylate (DMAEMA) into an poly(ethylene-co-tetrafluoroethylene)-graft-poly(styrene sulfonic acid) (ETFE-g-PSSA) film, and DMAEMA into a ETFE film under γ-irradiation, according to Example 1.

FIG. 2 is a series of FTIR spectra of various films: (A) ETFE, (B) poly(ethylene-co-tetrafluoroethylene)-graft-poly(styrene) (ETFE-g-PS), (C) ETFE-g-PSSA, and (D) AIEM-II, according to Example 2.

FIG. 3 is a series of XPS spectra of grafted films of (A) ETFE-g-PSSA and AIEM-II; (B) N 2 s curve-fitting of AIEM-II; (C)C is curve-fitting of ETFE-g-PSSA; and (D) C 1 s curve-fitting of AIEM-II, according to Example 3.

FIG. 4 is a graph illustrating the permeability of vanadium ions through various membranes (AIEM-II, ETFE-g-PSSA and Nafion 117 membranes).

FIG. 5 is an open circuit voltage (OCV) test of a vanadium redox flow battery (VRFB) with an AIEM-II membrane and a Nafion 117 membrane, according to Example 6.

FIG. 6 is a charge-discharge curve of VRFB with AIEM-II and Nafion 117 membrane, according to Example 6.

FIG. 7 is a cycle performance of VRFB with AIEM-II, according to Example 6.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here. The present technology is also illustrated by the examples herein, which should not be construed as limiting in any way.

In one aspect, an amphoteric ion exchange membrane (AIEM) is provided for a VRFB in which the membrane has a vanadium ion permeability of less than 10×10⁻⁹ cm²/min. In some embodiments, the vanadium ion permeability of the AIEM is less than 6×10⁻⁹ cm²/min. In other embodiments, the vanadium ion permeability of the AIEM is less than 3×10⁻⁹ cm²/min. The permeability of vanadium ions through the AIEM may be determined from the following equation, assuming pseudo steady-state conditions:

$$V \frac{d {c}_{t}}{d t} = S \frac{P}{L} ( {c}_{0} - {c}_{t} )$$

where V is the volume of the solution in both sides; S is the area of the membrane exposed to the solution; P is the permeability of vanadium ions; L is the thickness of the membrane; c₀ is the initial concentration of the VOSO₄ solution; cₜ is the vanadium concentration in MgSO₄ solution at time t. P is assumed to be independent of the concentration. The use of this equation assumes that the change in the concentration of VOSO₄ in solution is small enough to be negligible during the measurement. Such AIEMs have superior performance in comparison to commercially available anionic or cationic ion exchange membranes for use in VRFBs.

In another aspect, an AIEM includes a grafted polymer film represented by the following formula:

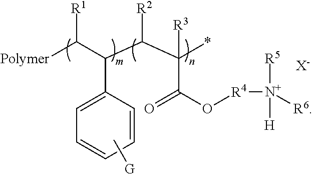

In the formula, R¹, R², R³, R⁵, and R⁶ independently represent a H, alkyl, alkenyl, alkynyl, cycloalkyl, or heterocyclyl group; R⁴ represents an alkylene or alkenyloxy group; X represents an anion; G is COOA, PO₄A, or SO₃A; A represents H, alkyl, or a cation; m is an integer from 100 to 10000; n is an integer from 60 to 6000; and x is an integer from 1 to 4. In some embodiments, G is SO₃A.

The polymer represented in the figure may be a polymer as known in the art that is configured to be used in membrane applications. For example, the polymer may include a poly(tetrafluoroethylene), crosslinked poly(tetrafluoroethylene), or a co-polymer of poly(tetrafluoroethylene). Such co-polymers may include, but are not limited to, poly(ethylene-co-tetrafluoroethylene), poly(vinylidene fluoride), poly(vinyl fluoride) (PVF), poly(tetrafluoroethylene-co-perfluorinated alkyl vinyl ethers), and poly(tetrafluoroethylene-co-hexafluoropropylene).

In some embodiments, R¹, R², R³, R⁵, and R⁶ independently represent H or alkyl. In some such embodiments, R¹, R², R³, R⁵, and R⁶ independently represent H or C₁-C₆ alkyl. In some embodiments, R¹ and R² are H. In other embodiments, R³, R⁵, and R⁶ are independently alkyl. In such other embodiments, R³, R⁵, and R⁶ are independently C₁-C₆ alkyl. In some embodiments, R¹ and R² are H and R³, R⁵, and R⁶ are independently alkyl. In some such embodiments, R¹ and R² are H and R³, R⁵, and R⁶ are independently C₁-C₆ alkyl. In some embodiments, R¹ and R² are H and R³, R⁵, and R⁶ are methyl. In some embodiments, R⁴ represents an alkylene group. In some embodiments, the alkylene group is a C₁-C₁₂ alkylene group. In some embodiments, R⁴ represents an alkylene group that is —CH₂— (i.e. methylene), —CH₂CH₂— (i.e. ethylene), —CH₂CH₂CH₂— (i.e. propylene), —CH₂(CH₃)CH₂— (i.e. iso-propylene), —CH₂CH₂CH₂CH₂— (i.e. butylene), etc. In some embodiments, R⁴ is a methylene or ethylene group. In some embodiments, R¹ and R² are H; R³, R⁵, and R⁶ are methyl; and R⁴ is a methylene or ethylene group.

In some embodiments, X is an anion as are known in the art to be stable with ammonium groups such as that depicted in the above figure. Accordingly, X may include, but is not limited to, one or more of F⁻; Cl⁻; Br⁻; I⁻; NO₃⁻; CN⁻; ClO₄⁻; BF₄⁻; AsF₆⁻; SbF₆⁻; PF₆⁻; CF₃SO₃⁻; Or B(C₆F₅)₄⁻.

According to various embodiments, the SO₃A group(s) on the phenyl ring may be located at any of the ring positions of the phenyl ring. For example, if a single SO₃A group is present it may be located ortho, meta, or para to the alkylene group to which the phenyl ring is attached. If more than a single SO₃A group is present the groups may be located at any available position on the phenyl ring. In some embodiments, A is H, alkyl, or a cation that is stable with the SO₃⁻ group. For example, A may be H, Na⁺, K⁺, or NR₄¹⁰, where each R¹⁰ is independently H or an alkyl group. For example, each R¹⁰ may be H or a C₁-C₁₂ alkyl. Accordingly, each R¹⁰ may be H, methyl, ethyl, n-propyl, iso-propyl, n-butyl, iso-butyl, tert-butyl, etc. In some embodiments, A represents H.

In some embodiments, x is 1, 2, 3, 4, or 5. In other embodiments, x is 1 or 2. In yet other embodiments, x is 1. In some embodiments, x is 1, A represents H, and the SO₃A group is located para to the alkylene group to which the phenyl ring is attached.

In some embodiments, m is from 500 to 8000. In other embodiments, n is from 300 to 6000. In some embodiments, m is from 500 to 8000 and n is from 300 to 6000.

In another aspect, a method for preparing the AIEM is provided. Such methods may include preparing a mixture of a polymer, a styrenic monomer, and a (meth)acrylic monomer. In some embodiments, the styrenic monomer is styrene or α-methylstyrene and the (meth)acrylic monomer is dimethylaminoethyl methacrylate. The mixture is then subjected to γ-irradiation at a dosage rate sufficient to cause a reaction between the polymer, the styrenic monomer, and the (meth)acrylic monomer. For example, the dosage rate may range from 10 to 50 Gray/min (Gy/min), from 20 to 40 Gy/min, or from 25 to 35 Gy/min, according to various embodiments. The irradiation may be conducted for a time period sufficient for the reaction to progress. For example, such time periods may range from 1 h to 24 h. From the reaction a grafted polymer film is produced having a grafting yield (GY) of from 10% to 100%. As used herein GY is calculated according to the following equation:

$$GY ( \% ) = \frac{{W}_{g} - {W}_{0}}{{W}_{0}} \times 100$$

where W_{g} and W₀ are film weights after and before grafting, respectively.

In some embodiments, the grafted polymer film is then sulfonated and hydrolyzed. The sulfonation may be conducted by the addition of chlorosulfonic acid, sulfuric acid, or sulfurous acid to the film in a solvent. Illustrative solvents include dichloromethane, 1,2-dichloroethane, water, dimethyl sulfoxide, N-methyl pryrrolidone, or dimethyl formamide. The sulfonation is carried out at a temperature sufficient for the reaction to progress and for a sufficient time period. For example, the sulfonation may be carried out from 25° C. to 100° C., from 30° C. to 75° C., or from 40° C. to 60° C., according to various embodiments. The hydrolysis may be carried out at an elevated temperature for a sufficient time period to hydrolyze the chlorosulfonyl group that was attached to the phenyl ring of the styrenic monomer grafted on the polymer. According to various embodiments, the hydrolysis may be carried out from 40° C. to 100° C., from 40° C. to 75° C., or from 45° C. to 55° C., for a period of from 1 h to 24 h.

In another aspect a vanadium redox flow battery (VRFB) is provided which includes any of the amphoteric ion exchange membranes described above. Such batteries have positive and negative half-cells that are separated by the amphoteric membrane. For example, the positive half-cell may include VO₂⁺ and VO²⁺ according to the half-cell reaction:

VO₂⁺_{(aq)}+2H⁺_{(aq)}+e⁻→VO²⁺_{(aq)}+H₂O₍ₗ₎

In the positive half-cell reaction, the VO²⁺ is a vanadium(IV) species and the VO₂⁺ is a vanadium(V) species. The negative half-cell may include V³⁺ and V²⁺ according to the half-cell reaction:

V³⁺+e⁻ [symbol] V²⁺.

The VRFB also includes an electrolyte. According to some embodiments, the electrolyte includes H₂SO₄. In other embodiments, the electrolyte includes other additives. Such other additives may include, but are not limited to ethylenediaminetetraacetic acid, pyridine, glycerine, and sodium sulfate.

Alkyl groups include straight chain and branched alkyl groups having from 1 to 20 carbon atoms, and typically from 1 to 12 carbons or, in some embodiments, from 1 to 8 carbon atoms. As employed herein, “alkyl” includes cycloalkyl groups as defined below. Examples of straight chain alkyl groups include methyl, ethyl, n-propyl, n-butyl, n-pentyl, n-hexyl, n-heptyl, and n-octyl groups. Examples of branched alkyl groups include, but are not limited to, isopropyl, sec-butyl, t-butyl, neopentyl, and isopentyl groups. Representative substituted alkyl groups may be substituted one or more times with, for example, amino, thio, hydroxy, cyano, alkoxy, and/or halo groups such as F, Cl, Br, and I groups. As used herein the term haloalkyl is an alkyl group having one or more halo groups. In some embodiments, haloalkyl refers to a per-haloalkyl group.

Cycloalkyl groups are cyclic alkyl groups such as, but not limited to, cyclopropyl, cyclobutyl, cyclopentyl, cyclohexyl, cycloheptyl, and cyclooctyl groups. In some embodiments, the cycloalkyl group has 3 to 8 ring members, whereas in other embodiments the number of ring carbon atoms range from 3 to 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined above. Representative substituted cycloalkyl groups may be mono-substituted or substituted more than once, such as, but not limited to: 2,2-; 2,3-; 2,4-; 2,5-; or 2,6-disubstituted cyclohexyl groups or mono-, di-, or tri-substituted norbornyl or cycloheptyl groups, which may be substituted with, for example, alkyl, alkoxy, amino, thio, hydroxy, cyano, and/or halo groups.

Alkenyl groups are straight chain, branched or cyclic alkyl groups having 2 to 20 carbon atoms, and further including at least one double bond. In some embodiments alkenyl groups have from 1 to 12 carbons, or, typically, from 1 to 8 carbon atoms. Alkenyl groups include, for instance, vinyl, propenyl, 2-butenyl, 3-butenyl, isobutenyl, cyclohexenyl, cyclopentenyl, cyclohexadienyl, butadienyl, pentadienyl, and hexadienyl groups among others. Alkenyl groups may be substituted similarly to alkyl groups. Divalent alkenyl groups, i.e., alkenyl groups with two points of attachment, include, but are not limited to, CH—CH═CH₂, C═CH₂, or C═CHCH₃.

Alkynyl groups are straight chain or branched alkyl groups having 2 to 20 carbon atoms, and further including at least one triple bond. In some embodiments alkynyl groups have from 1 to 12 carbons, or, typically, from 1 to 8 carbon atoms. Exemplary alkynyl groups include, but are not limited to, ethynyl, propynyl, and butynyl groups. Alkynyl groups may be substituted similarly to alkyl groups. Divalent alkynyl groups, i.e., alkynyl groups with two points of attachment, include but are not limited to CH—C≡CH.

As used herein, heterocyclyl groups include aromatic (also referred to as heteroaryl) and non-aromatic ring compounds containing 3 or more ring members, of which one or more is a heteroatom such as, but not limited to, N, O, and S. In some embodiments, heterocyclyl groups include 3 to 20 ring members, whereas other such groups have 3 to 6, 3 to 10, 3 to 12, or 3 to 15 ring members. Heterocyclyl groups include, but are not limited to, aziridinyl, azetidinyl, pyrrolidinyl, imidazolidinyl, pyrazolidinyl, thiazolidinyl, tetrahydrothiophenyl, tetrahydrofuranyl, dioxolyl, furanyl, thiophenyl, pyrrolyl, pyrrolinyl, imidazolyl, imidazolinyl, pyrazolyl, pyrazolinyl, triazolyl, tetrazolyl, oxazolyl, isoxazolyl, thiazolyl, thiazolinyl, isothiazolyl, thiadiazolyl, oxadiazolyl, piperidyl, piperazinyl, morpholinyl, thiomorpholinyl, tetrahydropyranyl, tetrahydrothiopyranyl, oxathiane, dioxyl, dithianyl, pyranyl, pyridyl, pyrimidinyl, pyridazinyl, pyrazinyl, triazinyl, dihydropyridyl, dihydrodithiinyl, dihydrodithionyl, homopiperazinyl, quinuclidyl, indolyl, indolinyl, isoindolyl, azaindolyl (pyrrolopyridyl), indazolyl, indolizinyl, benzotriazolyl, benzimidazolyl, benzofuranyl, benzothiophenyl, benzthiazolyl, benzoxadiazolyl, benzoxazinyl, benzodithiinyl, benzoxathiinyl, benzothiazinyl, benzoxazolyl, benzothiazolyl, benzothiadiazolyl, benzo[1,3]dioxolyl, pyrazolopyridyl, imidazopyridyl (azabenzimidazolyl), triazolopyridyl, isoxazolopyridyl, purinyl, xanthinyl, adeninyl, guaninyl, quinolinyl, isoquinolinyl, quinolizinyl, quinoxalinyl, quinazolinyl, cinnolinyl, phthalazinyl, naphthyridinyl, pteridinyl, thianaphthalenyl, dihydrobenzothiazinyl, dihydrobenzofuranyl, dihydroindolyl, dihydrobenzodioxinyl, tetrahydroindolyl, tetrahydroindazolyl, tetrahydrobenzimidazolyl, tetrahydrobenzotriazolyl, tetrahydropyrrolopyridyl, tetrahydropyrazolopyridyl, tetrahydroimidazopyridyl, tetrahydrotriazolopyridyl, and tetrahydroquinolinyl groups. Representative substituted heterocyclyl groups may be mono-substituted or substituted more than once, such as, but not limited to, pyridyl or morpholinyl groups, which are 2-, 3-, 4-, 5-, or 6-substituted, or disubstituted with various groups as defined above, including, but not limited to, alkyl, oxo, carbonyl, amino, alkoxy, cyano, and/or halogens.

As used herein, alkylene refers to a di-valent alkyl group that may be straight chain or branched and from 1 to 20 carbon atoms, and typically from 1 to 12 carbon atoms or, in some embodiments, from 1 to 8 carbon atoms. Examples of straight chain alkylene groups include methylene (—CH₂—), ethylene (—CH₂CH₂—), propylene (—CH₂CH₂CH₂— or —CH(CH₃)CH₂—), butylene (—CH₂CH₂CH₂CH₂— or branched versions thereof) and the like. Alkylene groups may be substituted one or more times with, for example, amino, thio, hydroxy, cyano, alkoxy, oxo, and/or halo groups such as F, Cl, Br, and I groups.

As used herein, alkenyloxy refers to an alkylene group having one or more oxygen atoms incorporated such that an ether structure is present, and which may be straight chain or branched and from 1 to 20 carbon atoms, from 1 to 12 carbon atoms or, in some embodiments, from 1 to 8 carbon atoms; and having 1 to 8 oxygen atoms, or 1 to 4 oxygen atoms.

As used herein, “amphoteric” refers to the ability of a substance to act as both a base and an acid. Amphoteric ion exchange membranes therefore have basic regions and acidic regions, and which have exchange ability of both cations and anions simultaneously.

One skilled in the art will readily realize that all ranges discussed can and do necessarily also describe all subranges therein for all purposes, and that all such subranges also form part and parcel of this disclosure. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

The present technology, thus generally described, will be understood more readily by reference to the following examples, which are provided by way of illustration and are not intended to be limiting.

### EXAMPLES

The present technology is further illustrated by the following examples, which should not be construed as limiting in any way.

### Example 1

### Preparation of an AIEM

Poly(Ethylene-Co-tetrafluoroethylene) (ETFE) film (25 μm) was provided by Asahi Glass Co. (Japan) and washed with acetone to remove any impurity on its surface before use. Styrene and dimethylaminoethyl methacrylate (DMAEMA; Acros) with purity of more than 99% was used without further purification. Chlorosulfonic acid was purchased from Beijing Yili Fine Chemical Co. LTD. VOSO₄.3H₂O was supplied by Shanghai LvYuan Fine Chemical Plant.

Scheme 1 illustrates the preparation of an AIEM. ETFE film with known weight was immersed into a monomer solution and bubbled with nitrogen for about 15 min and sealed. Then the sample was subjected to γ-irradiation from a ⁶⁰Co source (Peking University). After irradiation at a dosage rate of 30 Gy/min, the film was placed in a soxhlet extractor with a solvent of either toluene or acetone. The remaining film was dried to constant weight under vacuum and weighed.

The grafted films were then sulfonated in a 0.2M chlorosulfonic acid solution of 1,2-dichloroethane at 50° C. for 6 h, and hydrolyzed with distilled water at 60° C. for 12 h. The dried ETFE-g-PSSA membranes were subsequently immersed in 1M DMAEMA solution and irradiated under N₂ atmosphere. The GY of DMAEMA in this step was also calculated according to Eq. (1).

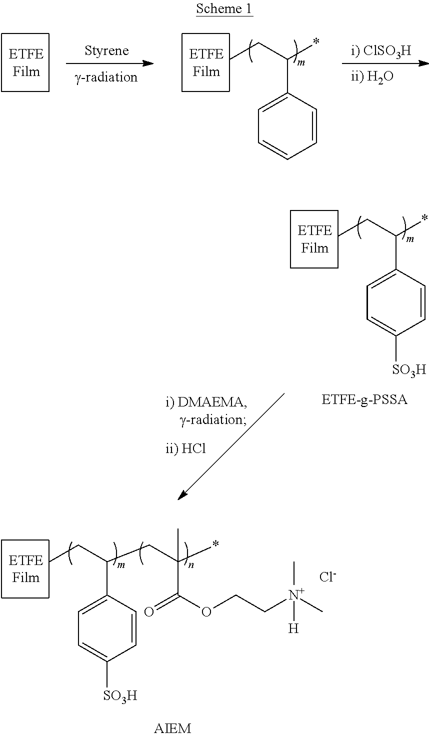

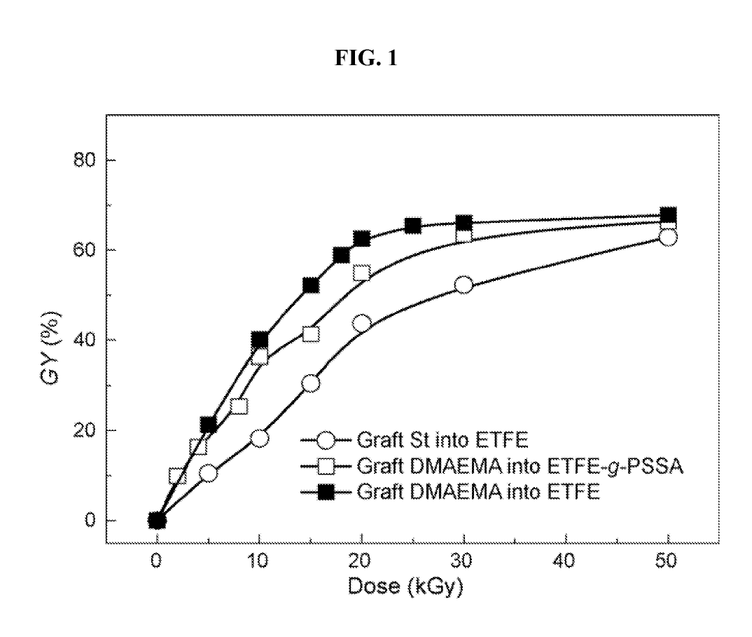

The preparation route of the AIEM includes the respective grafting of styrene and DMAEMA and subsequent treatment steps (Scheme 1). The effect of an absorbed dose on the GY of styrene and DMAEMA was investigated and the results were demonstrated in FIG. 1. For the grafting of styrene into ETFE film, the GY increases rapidly before 30 kGy and then levels off. The grafted film was then sulfonated in chlorosulfonic acid, giving anionic groups in ETFE-g-PSSA membrane. Successive grafting of DMAEMA into ETFE-g-PSSA membrane indicates that the GY increases with dose, and then levels off after about 20 kGy. Moreover, it can be seen that higher GY can be obtained by directly grafting DMAEMA into ETFE film. This is because the swelling of ETFE-g-PSSA membrane is less than ETFE film in acetone. The grafted DMAEMA unit was subsequently protonated, resulting in fixed cationically charged groups in the membrane. In this way, both cationic and anionic groups are introduced into the membrane. It is expected that the membrane would possess low permeability of vanadium ions as a result of the Donnan exclusion effect, which is a result of the repulsion between the cation groups on the AIEM and the vanadium ions, while maintaining high conductivity. On the other hand, the properties of the AIEM are adjustable by changing the grafting conditions. Two kinds of AIEM were synthesized and used for further comparison: GY of styrene and DMAEMA for AIEM-I are 14.3% and 12.3%, while that for AIEM-II are 16.4% and 23.1%, respectively.

### Example 2

### FTIR Analysis

Micro-FTIR analysis was performed on a Nicolet spectrometer (Magna-IR 750). The spectra were measured at absorbance mode in a wave number range of 4000-600 cm⁻¹.

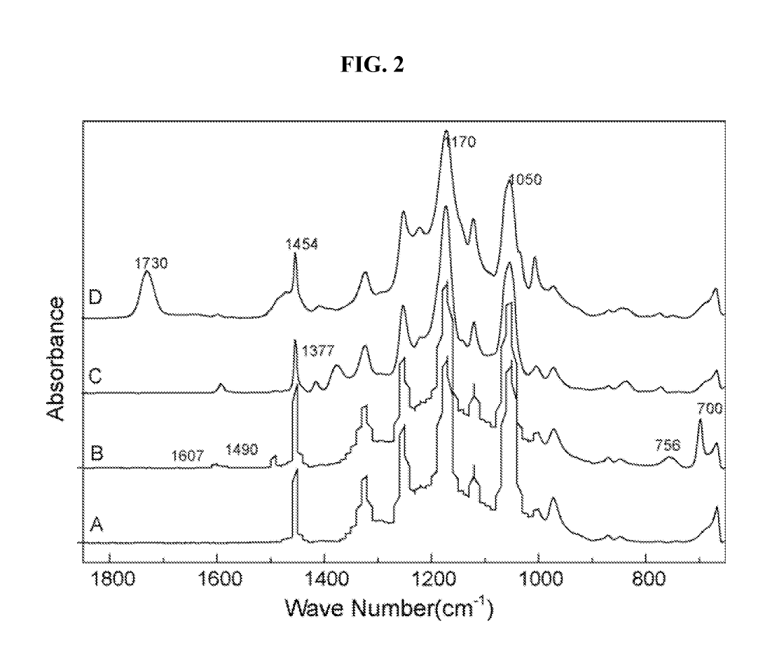

FIG. 2 exhibits the FTIR spectra of ETFE film, ETFE-g-PS, ETFE-g-PSSA and AIEM-II. For the ETFE film (FIG. 2A), the sharp absorption at 1454 cm⁻¹ is due to the C—H deformation vibration, whereas the strong absorption bands at wave number range of 1000-1300 cm⁻¹ are assigned to the absorption of CF₂ groups. After grafting with styrene (FIG. 2B), the presence of the benzene ring in styrene unit is verified by the skeletal C═C in-plane and stretching vibrations at 1490 cm⁻¹ and 1607 cm⁻¹, respectively. The mono-substitution of the benzene ring is confirmed by the aromatic out-of-plane C—H deformation bands at 700 cm⁻¹ and 756 cm⁻¹. It has been known that the asymmetrical stretching vibrations of sulfonic acid groups appear at about 1180 cm⁻¹, but it could not be readily observed due to near overlapping absorption bands. However, from the new absorption band at 1377 cm⁻¹ which can be assigned as the asymmetric stretching of S═O band, it can still be concluded that the membrane has been sulfonated (FIG. 2C). Moreover, the absorption bands attributing to the mono-substituted benzene ring at 764 and 700 cm⁻¹ disappear, which also indicates that the benzene ring in styrene has been completely sulfonated. The grafting of DMAEMA is established by the new absorption band at 1730 cm⁻¹, which is due to the stretch vibration of carbonyl group (C═O) in the ester bond of DMAEMA (FIG. 2D).

### Example 3

### XPS Analysis

X-ray photoelectron spectroscopy (XPS) analysis was performed with an AXIS-Ultra instrument from Kratos Analytical using monochromatic Al Kα radiation (225 W, 15 mA, 15 kV) and low energy electron flooding for charge compensation. To compensate for surface charge effects, binding energies were calibrated using a C is hydrocarbon peak at a binding energy (BE) of 284.8 eV. The data were converted into VAMAS file format and imported into CASA XPS software package for manipulation and curve fitting.

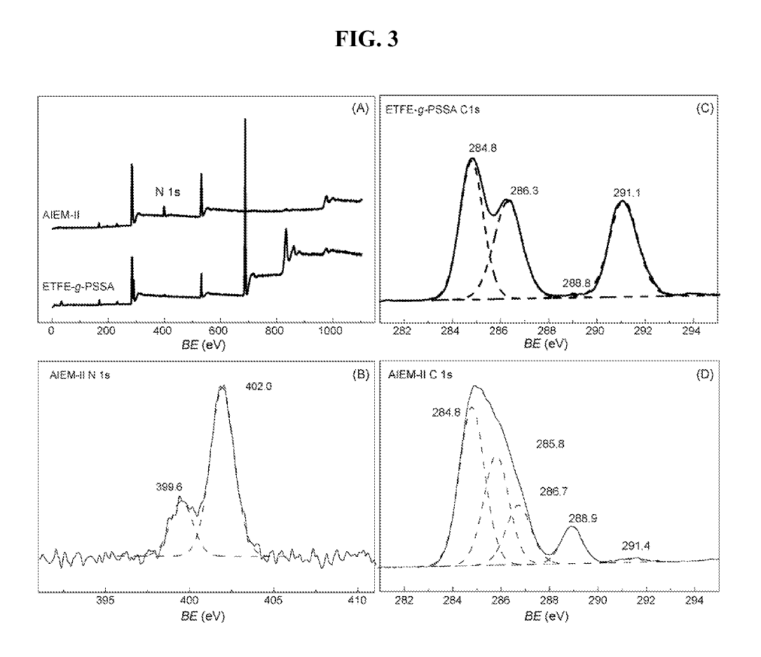

FIG. 3 demonstrates the XPS analysis of ETFE-g-PSSA membrane and the AIEM-II. After grafted with DMAEMA, a N 1 s peak at about 400 eV was observed, indicating the successful grafting of DMAEMA (FIG. 3A). The N 1 s peak can be curve-fitted with two peak components at BEs of 399.6 and 402.0 eV (FIG. 3B), attributing to —N(CH₃)₂ and —NH(CH₃)₂⁺, respectively, which indicates that most of the —N(CH₃)₂ groups in the grafts have been protonated. Moreover, the C is peaks of the ETFE-g-PSSA membrane can be curve-fitted with four components with BEs at 284.8, 286.3, 288.8 and 291.1 eV, respectively. According to the literature, the peak components at BEs of 284.8 and 291.1 eV can be attributed to the C—H in CH₂ and C—F in CF₂ bonds, while that at BEs of 286.3 and 288.8 eV are assigned to the C═C bond and C—S bond of the sulfonated benzene rings in styrene unit, respectively (FIG. 3C). After subsequently grafted with DMAEMA (FIG. 3D), the new peak component at BE of 285.8 eV is due to the C—N bond in DMAEMA, while the enhanced peak component at BE of 288.8 eV is ascribed to (O)C—O in DMAEMA unit. The results further testify the grafting of DMAEMA into the ETFE-g-PSSA membrane.

### Example 4

### IEC Analysis

Both the cationic and anionic ion exchange capacity (IEC) were, respectively, determined and calculated. Conductivity (σ) of the AIEM was obtained by impedance spectroscopy measurement using a CHI660 electrochemical Work Station. The AIEM was hydrated in deionized water for 24 h before determination and clamped between two Pt electrodes for recording of the impedance spectroscopy. σ was calculated as: σ=L/(R×S), where R is the real impedance taken at zero imaginary impedance in the impedance spectroscopy; L and S are thickness and area of the AIEM between the electrodes, respectively. Water uptake of the membrane was calculated as: water uptake (%)=100×(W_{w}−W_{d})/W_{d}, where W_{w} and W_{d} are the weights of the AIEM in the wet and dry state, respectively.

IEC, conductivity, and water uptake of the AIEM-I and AIEM-II are listed in Table 1 and compared with those of a sulfonated tetrafluoroethylene based fluoropolymer-co-polymer (Nafion 117). It can be observed that the conductivity of the membrane further increased by ca. 63% after 12.3% DMAEMA grafted into ETFE-g-PSSA membrane. Comparing AIEM-I with AIEM-II, it can be found that IEC, water uptake and conductivity of the membrane increase as more DMAEMA incorporated. For the AIEM-II with a GY of styrene as 16.4% and GY of DMAEMA as 23.1%, the membrane exhibits close IEC, water uptake and conductivity to the Nafion 117 membrane.

### Example 5

### Permeability Investigation

The permeability of vanadium ions through the AIEM was investigated. The membrane was exposed to a solution of 1.5M VOSO₄ in 2.5M H₂SO₄ on one side and 1.5M MgSO₄ in 2.5M H₂SO₄ on the other side. MgSO₄ was used to balance the ionic strength and to minimize the osmotic pressure between the left and right sides of the membrane. The area of the membrane exposed to the solution was 1.77 cm² while the volume of both solutions was 25 ml. The MgSO₄ solution was taken at regular time and analyzed using inductively coupled plasma atomic emission spectrometry (ICPAES, Leeman, Profile).

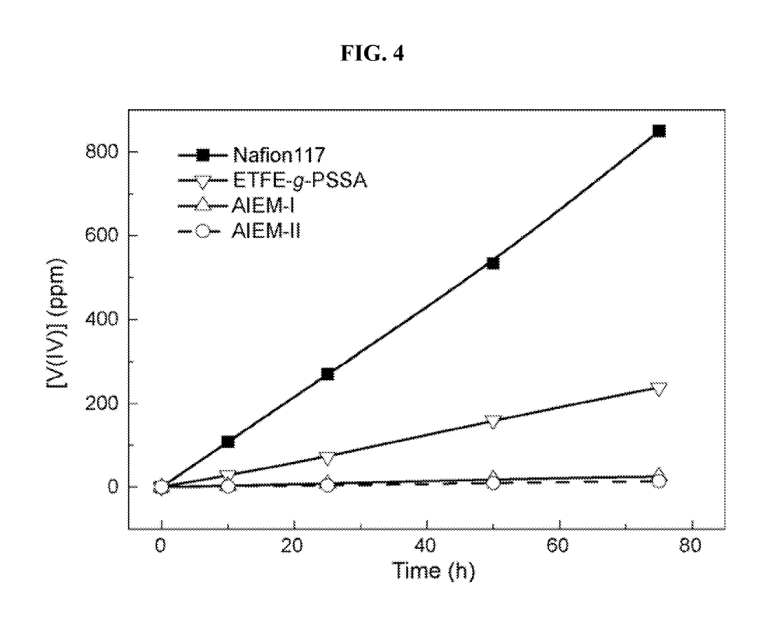

The vanadium crossover has been a serious problem of VRFB, as in that situation, electrochemical energy loss and energy efficiency reduction will be unavoidable. Consequently, the permeability of vanadium ions through the IEM determines its applicability in the battery. The change of the vanadium concentration in MgSO₄ solution with the time is shown in FIG. 4. The vanadium concentration through the Nafion 117 membrane increased much faster than that through the AIEM. According to FIG. 4 and Eq. (2), the permeability of vanadium ions (P) is calculated and listed in Table 1. It is shown that P through the AIEM-II is dramatically lower than that through ETFE-g-PSSA and Nafion 117 membrane: P through the AIEM is only 1/130- 1/200 of that through the Nafion 117 membrane. Moreover, as the GY of DMAEMA increases from 12.3% to 23.1% (AIEM-I to AIEM-II), P further decreases by about 40% as a result of much stronger Donnan exclusion effect between AIEM-II and vanadium ions. It has been reported that multivalent cations are difficult to be adsorbed on the cationic charged layer compared to monovalent cations as a result of Donnan exclusion effect. The extremely low P is owing to the Donnan exclusion effect between —R₃NH⁺ in protonated DMAEMA unit and vanadium ions. It has also been shown that low P can be obtained by modifying Nafion membranes with cationic charged groups, which is similarly ascribed to a Donnan exclusion effect.

TABLE 1
Comparison of the general properties of AIEM-I, AIEM-II, ETFE-g-PSSA and
Nafion 117 membrane.

| | | | | | | Water | | |
|---|---|---|---|---|---|---|---|---|
| | Thickness | GY (%) | | IEC (mmol/g) | | uptake | σ | P (10⁻⁹ |
| Membrane | (μm) | Styrene | DMAEMA | Cationic | Anionic | (%) | (S/cm) | cm²/min) |
| AIEM-I | 43 | 14.3 | 12.3 | 0.95 | 0.63 | 26.4 | 0.039 | 5.21 |
| AIEM-II | 45 | 16.4 | 23.1 | 1.06 | 1.24 | 36.1 | 0.048 | 2.90 |
| ETFE-g- | 38 | 14.9 | — | 0.88 | — | 14.7 | 0.024 | 39.0 |
| PSSA | | | | | | | | |
| Nafion | 178 | — | — | 0.98 | — | 30.4 | 0.058 | 685 |
| 117 | | | | | | | | |

### Example 6

### VRFB Fabrication

The VRFB for the charge-discharge test was fabricated by sandwiching the AIEM membrane between two pieces of graphite carbon electrodes and using 1.5M V(II)/V(III) and V(IV)/V(V) in 2.5M H₂SO₄ solution as the electrolytes in negative and positive half cells, respectively. The membrane area was 5 cm² and the volume of the electrolytes solution in each half cell was 40 ml. The VRFB was charged to 1.6V and discharged to 0.8V at a constant current density of 40 mA/cm². The OCV and charge-discharge test was carried out using Land CT2001A battery test system at room temperature. The coulombic efficiency (CE), voltage efficiency (VE) and energy efficiency (EE) are calculated according to the following equations:

$$CE ( \% ) = 100 \times \frac{{C}_{d}}{{C}_{c}}$$

$$VE ( \% ) = 100 \times \frac{{V}_{d}}{{V}_{c}}$$

$$EE = CE \times VE$$

where C_{d} and C_{c} are discharge and charge capacity, and V_{d} and V_{c} are the middle point voltage of discharge and charge, respectively.

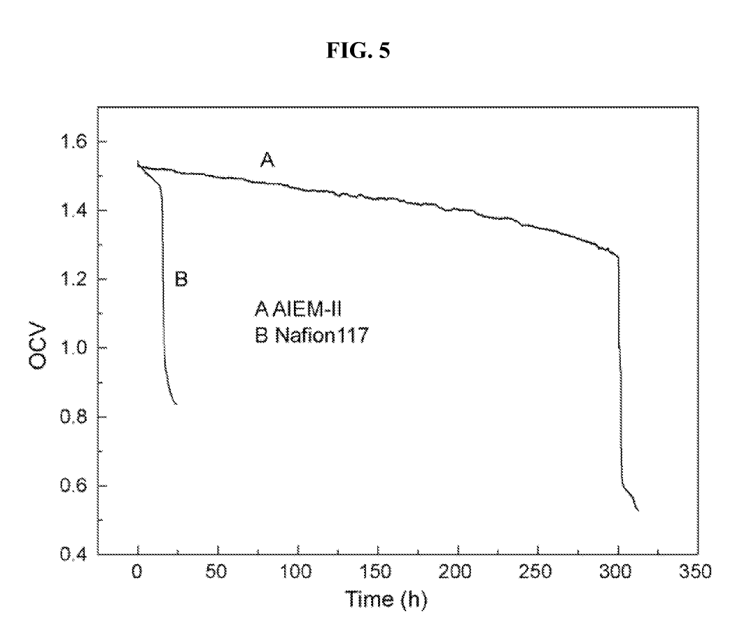

An OCV test comparison of a VRFB with Nafion 117 and with AIEM-II is shown in FIG. 5. The OCV test in a VRFB assembled with Nafion 117 membrane decreased rapidly after staying nearly constant for about 14 h. In contrast, the VRFB assembled with AIEM-II exhibits more robust performance, maintaining the OCV test above 1.3V for more than 300 h. The OCV performance indicates that the self-discharge of VRFB with AIEM-II is evidently suppressed compared to that of conventional IEMs. This directly corresponds to the permeability test, i.e. a lower P of vanadium ions results in less self-discharge of the battery. Accordingly, due to the better performance on restricting the crossover of vanadium ions, the AIEM is expected to posses high CE of the battery.

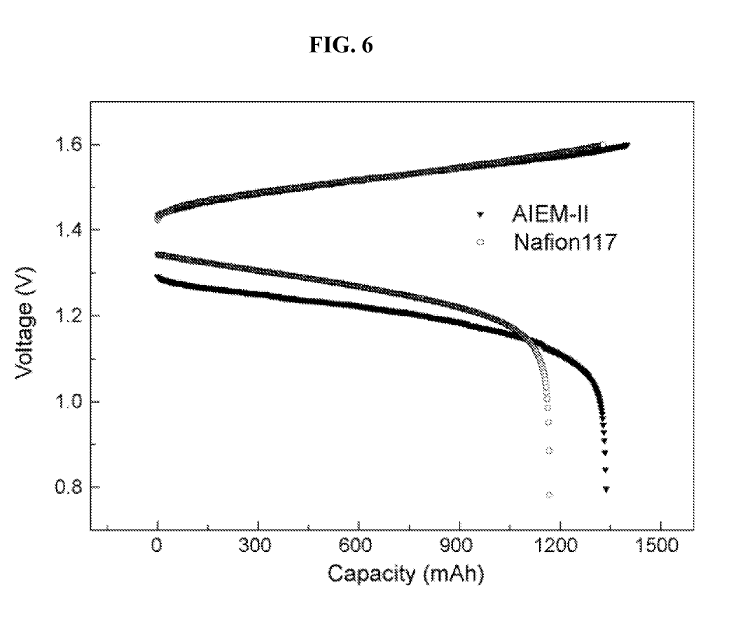

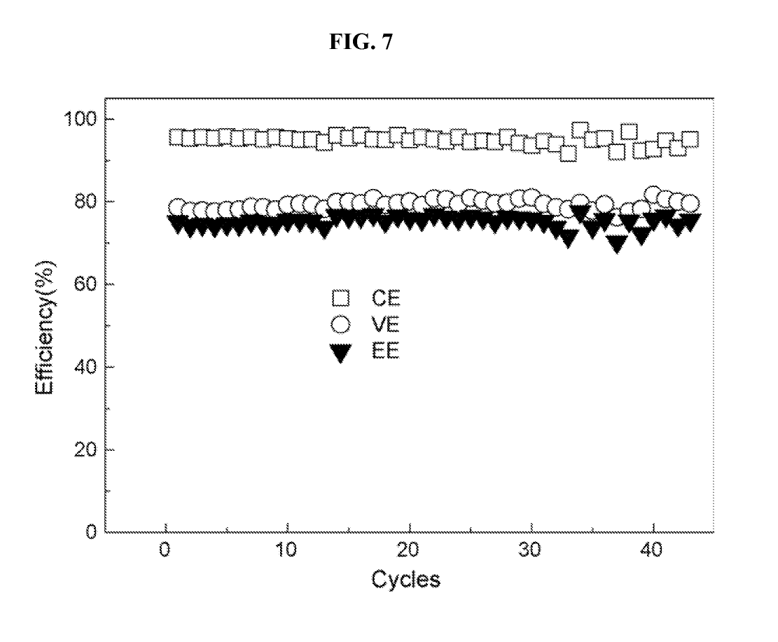

The charge-discharge curves of VRFB fabricated with AIEM-II and Nafion 117 membrane are presented in FIG. 6. Both batteries are charged to 1.6V and discharged to 0.8V at a constant current density of 40 mA/cm². As demonstrated in FIG. 6, the discharge voltage of VRFB with the Nafion 117 membrane is higher than that with AIEMII, which is attributed to the higher conductivity of the Nafion 117 membrane. As a result, the VE of VRFB with the AIEM (78.6%) is lower than that with the Nafion 117 membrane (82.6%). However, as a result of the much lower P of vanadium ions, the coulombic efficiency (CE) of VRFB with AIEM-II (95.6%) is much higher than that with the Nafion 117 membrane (87.9%). The overall energy efficiency (EE) of VRFB with the AIEM (75.1%) is also higher than that with the Nafion 117 membrane (72.6%). Furthermore, the cycle performance of VRFB employing AIEM-II is evaluated at the same conditions (FIG. 7). After testing for more than 40 cycles, no efficiency decline is observed, which indicates that the AIEM exhibits good chemical stability in VRFB electrolytes.

### EQUIVALENTS

While certain embodiments have been illustrated and described, it should be understood that changes and modifications can be made therein in accordance with ordinary skill in the art without departing from the technology in its broader aspects as defined in the following claims.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds compositions or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

Other embodiments are set forth in the following claims.

What is claimed is:

1. An amphoteric ion exchange membrane for use in a vanadium redox flow battery, the membrane having a vanadium ion permeability of less than 10×10⁻⁹ cm²/min.

2. The amphoteric ion exchange membrane of claim 1, wherein the vanadium ion permeability is less than 6×10⁻⁹ cm²/min.

3. The amphoteric ion exchange membrane of claim 1, wherein the vanadium ion permeability is less than 3×10⁻⁹ cm²/min.

4. The amphoteric ion exchange membrane of claim 1, comprising a grafted polymer film represented by the following formula: 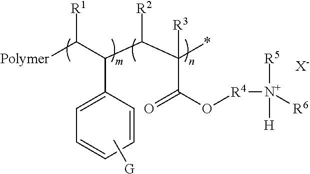
wherein:
R¹, R², R³, R⁵, and R⁶ are independently H, alkyl, alkenyl, alkynyl, cycloalkyl, or heterocyclyl;
R⁴ is an alkylene or alkenyloxy;
X is an anion;
G is COOA, SO₃A, or PO₄A;
A is H or a cation;
m is an integer from 100 to 10000;
n is an integer from 60 to 6000; and
x is an integer from 1 to 5.

5. The amphoteric ion exchange membrane of claim 4, wherein R¹, R², R³, R⁵, and R⁶ are independently H or alkyl.

6. The amphoteric ion exchange membrane of claim 4, wherein R¹, R², R³, R⁵, and R⁶ are independently H or C₁-C₆ alkyl.

7. The amphoteric ion exchange membrane of claim 4, wherein R¹ and R² are H.

8. The amphoteric ion exchange membrane of claim 4, wherein R¹ and R² are H and R³, R⁵, and R⁶ are methyl.

9. The amphoteric ion exchange membrane of claim 4, wherein R⁴ is alkylene.

10. The amphoteric ion exchange membrane of claim 4, wherein R⁴ is C₁-C₁₂ alkylene.

11. The amphoteric ion exchange membrane of claim 4, wherein R¹ and R² are H; R³, R⁵, and R⁶ are methyl; and R⁴ is —CH₂— or —CH₂CH₂—.

12. The amphoteric ion exchange membrane of claim 4, wherein X is F⁻; Cl⁻; Br⁻; I⁻; NO₃⁻; CN⁻; ClO₄⁻; BF₄⁻; AsF₆⁻; SbF₆⁻; PF₆⁻; CF₃SO₃⁻; or B(C₆F₅)₄⁻.

13. The amphoteric ion exchange membrane of claim 4, wherein each A is independently H, Na⁺, K⁺, or NR₄¹⁰, and each R¹⁰ is independently H or alkyl.

14. The amphoteric ion exchange membrane of claim 4, wherein the polymer comprises poly(ethylene-co-tetrafluoroethylene).

15. An vanadium redox flow battery comprising the amphoteric ion exchange membrane of claim 4.

16. A method comprising:
preparing a mixture of a polymer, a styrenic monomer, and a (meth)acrylic monomer;
subjecting the mixture to γ-ray irradiation to produce a grafted polymer film;
sulfonating the grafted polymer film to form a sulfonated grafted polymer film; and
hydrolyzing the sulfonated grafted polymer film to produce an amphoteric ion exchange membrane.

17. The method of claim 16, wherein the styrenic monomer is styrene.

18. The method of claim 16, wherein the (meth)acrylic monomer is dimethylaminoethyl methacrylate.

19. The method of claim 16, wherein the sulfonating comprises reacting the grafted polymer film with chlorosulfonic acid.
